(19) United States
(12) Patent Application Publication
(10) Pub. No.: US 2005/0075839 A1
(43) Pub. Date: Apr. 7, 2005

(54) Electrical equipment monitoring

(76) Inventor: Dave Rotheroe, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/670,087

(22) Filed: Sep. 24, 2003

(51) Int. Cl. G06F 19/00

(52) U.S. Cl. 702/183

(57) ABSTRACT

In one exemplary disclosed embodiment, a method of monitoring measured parameters associated with each piece of equipment in an array of electronic equipment is provided. The method involves retrieving data representing the measured parameters from a database, mapping the measured parameters to color codes, and displaying a graphic representation of the array of electronic equipment. In the graphic representation, each piece of electronic equipment in the array is represented with the color mapped to a measured parameter associated with the piece of electronic equipment.

### CROSS REFERENCE TO RELATED DOCUMENTS

This application is related to the co-pending U.S. patent application identified by Ser. No. ______, being further identified by Docket Number 200300848-1, filed of even date herewith, entitled “Power Cord with Monitor Circuit” by Rotheroe, which has the same ownership as the present application and to that extent is related to the present application and which is hereby incorporated by reference.

### BACKGROUND

Several techniques are currently in use to measure the current drawn by a piece of electronic equipment. Using one technique, the current can be measured by use of a current meter that clamps around the power cord of alternating current (AC) powered equipment. In this technique, the power cord induces current into a secondary coil in the current meter that permits measurement of the current. In another technique, the power line is open circuited with a current meter disposed in series with one of the power lines.

These techniques might be used by service technicians seeking to determine a current associated with a piece of equipment. However, there is generally no mechanism in place to remotely monitor the current, temperature or other parameter of a piece of electronic equipment such as a computer or multiple computers and display the results in an easily interpreted manner.

### BRIEF DESCRIPTION OF THE DRAWINGS

FIG. 1 is a block diagram of an exemplary portion of a monitoring arrangement consistent with certain embodiments.

FIG. 2 is an exemplary two-dimensional display of the monitored equipment consistent with certain embodiments.

FIG. 3 is an exemplary two-dimensional display of a complex array of monitored equipment consistent with certain embodiments.

FIG. 4 is an exemplary two-dimensional display of a top view the monitored equipment consistent with certain embodiments.

FIG. 5 is an exemplary three-dimensional display of the monitored equipment consistent with certain embodiments.

FIG. 6 is another exemplary three-dimensional display of the monitored equipment consistent with certain embodiments.

FIG. 7 is a flow chart of a data initialization and data maintenance phase of a process for display of the monitored equipment consistent with certain embodiments.

FIG. 8 is a flow chart of a display process for monitoring equipment consistent with certain embodiments.

FIG. 9 is a flow chart of the process carried out in Blocks 156 and 168 of FIG. 8 consistent with certain embodiments.

FIG. 10 is a flow chart of an exemplary process consistent with certain embodiments.

FIG. 11 is another flow chart of an exemplary process consistent with certain embodiments.

FIG. 12 is another flow chart of an exemplary process consistent with certain embodiments.

FIG. 13 is another flow chart of an exemplary process consistent with certain embodiments.

### DETAILED DESCRIPTION

There is shown in the drawings and will herein be described in detail specific embodiments, with the understanding that they are to be considered as exemplary and are not intended to be limiting. In the description below, like reference numerals are used to describe the same, similar or corresponding parts in the several views of the drawings.

There are many applications where it would be desirable to measure the current, power, voltage, temperature or other operational parameter associated with a piece of data processing equipment on a regular basis, without the use of temporary setups typically required. One exemplary embodiment might be in a computer room containing multiple computers that are interconnected to service a large scale web site, or a database service. In such a situation, a change in current, voltage, power, temperature or some other parameter might provide early warning that a piece of equipment is about to fail or has failed. Other environments can also benefit from the ability to remotely detect a change in an electrical parameter of a piece of electronic equipment.

In accordance with certain embodiments, multiple pieces of equipment can be monitored at the same time in a manner that allows a technician to easily monitor a large quantity of equipment locally or remotely and readily discern areas of trouble or potential trouble. This can be accomplished by mapping the parameter to a color-coded graphical display that makes problem areas easily spotted. Thus, in accordance with certain embodiments, a software tool is provided for monitoring of temperature, power or other parameters of equipment (e.g., in a data center) and displaying them in a visual manner. While tools exist to monitor data center temperature, they typically rely on only a few wall mounted temperature sensors, or at most one per cabinet. Likewise, power is typically monitored at a high level, such as total power, or power out of each few hundred amp feed. Certain embodiments described herein provide significant temperature and power consumption data at a low granular level in an easily viewable manner.

In the above-referenced copending patent application, various methods and apparatus are described in which a power cord incorporates a parameter measurement apparatus. In such a device, a signal is produced by, for example, a current or voltage measurement circuit that can be made available at an output terminal. This permits the signal representative of, for example, the current in the power cord to be sent to a remote location for monitoring. An intelligence module receives these signals and allows the aggregation of multiple monitored power cords to a single address. Availability of the data from the intelligence module can then be provided using Internet connection, SNMP (Simple Network Management Protocol), serial, or any other method. Such a device can be used to capture certain data of interest in connection with implementation of certain embodiments.

In addition to, or in place of, the power cord mechanism for measurement of certain electrical parameters, such equipment can be manufactured with integral capabilities to measure certain operational parameters. By way of example, and not limitation, many computer devices currently measure the temperature of the central processor and use this measurement to control the operation of a cooling fan. This information can be obtained without modification from many computers and can thus be sent, e.g., via a local area network connection, to a remote location for monitoring. Other useful parameters such as current drain and temperatures in other locations of a particular piece of equipment can be readily monitored by use of temperature sensors (e.g., thermistors and the like), and provided as an output signal in order to support the functionality of certain embodiments. In other embodiments, temperature sensors and appropriate communication devices can be attached to the outside of a piece of equipment at the exhaust fan or an exhaust port. In other embodiments, temperature monitoring devices can be built into or added to the inside of such equipment.

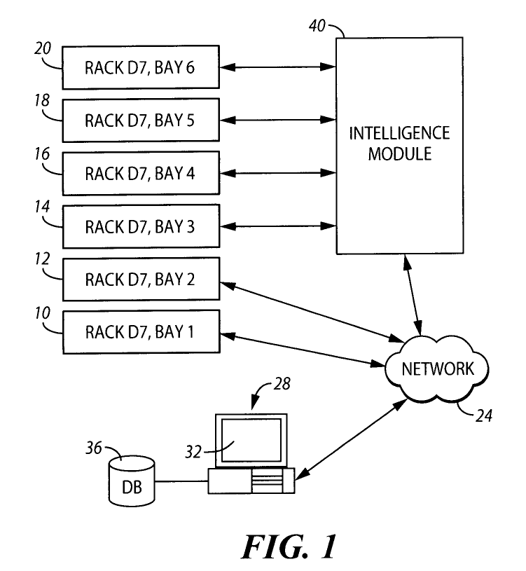

By way of example, and not limitation, an exemplary equipment room may have a plurality of pieces of equipment as depicted in FIG. 1. In this exemplary embodiment, the equipment may be mounted in a rack and identified by a rack identifier (D7) and a bay number (1-6). As illustrated, six such items of equipment are shown 10, 12, 14, 16, 18 and 20. These items of equipment may be vertically mounted so that the rack identifier and bay number uniquely identifies the device. In the case of equipment 10 and 12, these devices are designed to provide a connection, e.g., an Ethernet connection, to a network 24 so that parameters such as voltage, current and temperature can be obtained via the network using a computer 28. Computer 28 incorporates a display 32 used to graphically represent the data as will be explained later. Computer 28 also incorporates mass storage 36 used to contain a database and other information as will be described later.

Equipment 14, 16, 18 and 20 also provide data representing their operational parameters to computer 28 via network 24. In this case, however, the information is provided using an intelligence module, for example similar to that described in the copending patent application mentioned above. In this case, intelligence module 40 aggregates the data from the equipment 14, 16, 18 and 20 and interfaces with the network using a single address. The parameter measurement circuitry may be either built into the equipment or added on depending upon the situation.

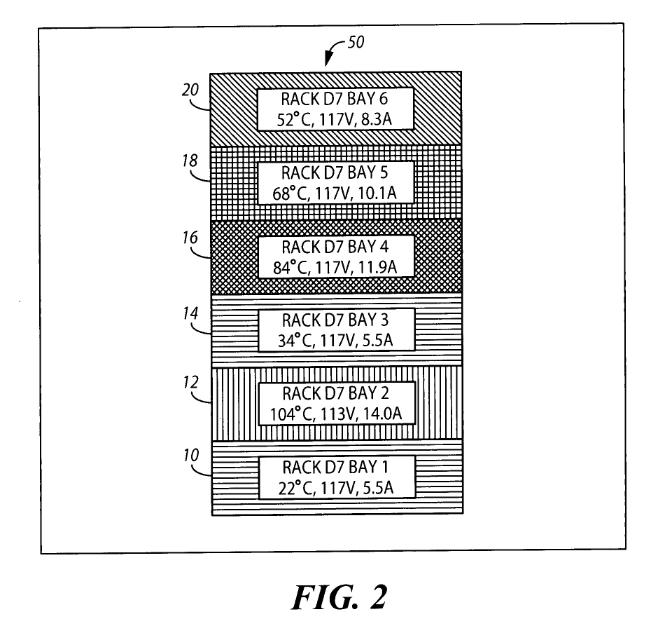

In accordance with certain embodiments, the information collected in computer 28 is displayed in a user friendly and user navigable manner on display 28. For example, for the equipment arrangement shown in FIG. 1, the data may be displayed in the manner depicted in FIG. 2. In FIG. 2, the equipment rack is depicted graphically as 50 with each piece of equipment shown in the configuration it appears in the rack. Each piece of equipment is shown with a color-coding (shown in the drawings as various hash marks to facilitate black and white line drawing depiction of the color-coding) depicting an operational parameter of the equipment. In this example, the coloration is mapped to temperature. The cooler bays such as 10 and 14 are shown, for example, in blue. Intermediate temperatures such as 20 and 18 may, for example, be shown as green and yellow. Higher temperature equipment such as 16 and 12 can be depicted, for example as orange and red. One exemplary temperature mapping, albeit somewhat arbitrary, might be as follows:

| Temperature | Color | Interpretation | Comment |
|---|---|---|---|
| | White | Not present | Equipment not present |
| | Gray | Error/Can't read | Unable to obtain an |
| | | | equipment reading |
| <40° C. | Blue | Cool temperature | Great temperature |
| | | range | |
| 40-60° C. | Green | Normal | Good temperature |
| | | temperature range | |
| 60-80° C. | Yellow | Warm temperature | Above desired operating |
| | | range | temperature, but acceptable |
| 80-100° C. | Orange | Hot temperature | Significantly above desired |
| | | range | operating range - long term |
| | | | reliability of hardware |
| | | | compromised |
| >100° C. | Red | Dangerously hot | In danger of shutdown, |
| | | temperature range | reliability of hardware |
| | | | compromised |

Other mappings can be defined depending upon experience with the equipment at hand and can be done using discrete temperature scales or a more continuous temperature/color scale, for example, patterned after colors of the color spectrum with bluer colors representing cool and redder colors representing hot. In the above example, five colors are used, but any number could have been used. Five colors designate the measured temperature, gray indicates error/can't read and white indicates that no equipment is present. In another embodiment, the white category can be further separated into white for no equipment present and beige for not monitored.

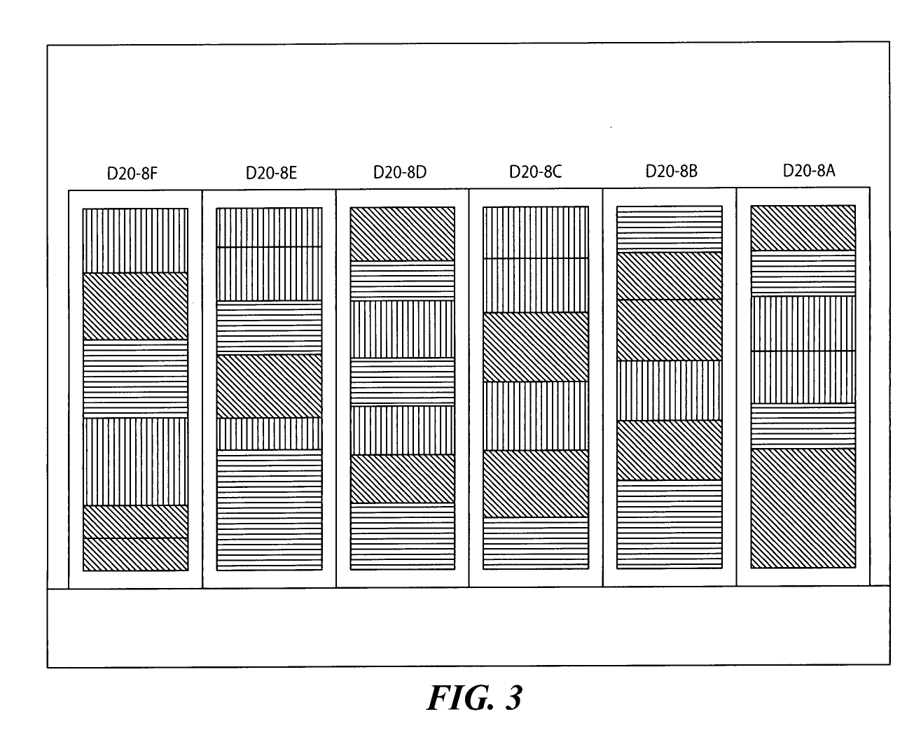

The display of FIG. 2 depicts a single rack of equipment within six bays and may be relatively easy to track even without the color-coding described above. However, the problem of monitoring a large number of pieces of equipment makes the value of the color-coding apparent. Consider, for example, the multi-column rack shown in FIG. 3. In this example, a large number of different pieces of equipment are to be monitored. By use of a set of color codes to depict the electronic parameter of interest, a person monitoring the equipment can readily discern problem areas at a glance without need to see detailed information on all of the pieces of equipment. In this figure, each box represents a different piece of equipment; the color (represented by various hash marks) indicates the temperature range it falls into according to the user-defined ranges. The actual temperature could also be displayed if available. By “clicking” on a box (e.g., pointing to a desired box with a mouse and actuating a mouse button), more information can be obtained for that particular piece of equipment. The numbers over the top of the rack are the rack name, which in one example, can be related to a coordinate grid within the data center. In this example, it is easy to see that providing the graphical representation of the equipment facilitates monitoring of many pieces of equipment simultaneously.

While the data are also available in numeric form, color-coding the various temperature ranges provides a visual display of the racks or stand alone equipment that can quickly and visually indicate problems with temperature in the data center. In addition to temperature, other parameters such as power can similarly be color coded and displayed both by color-coding and by use of numeric values.

The view depicted on FIG. 3 may be adequate for monitoring of a single bank of equipment carried in a multiple rack configuration with all racks side by side, but many data centers and other facilities are arranged in other configurations. Consider, for example, a room with two parallel multiple rack server arrangements in the middle of the room with additional equipment arranged along the walls. There might be no single view of such an arrangement that depicts the equipment in a manner that can be easily monitored. In such a case, in accordance with certain embodiments, a three-dimensional view of the room can be constructed and displayed. The computer operator that monitors the equipment can then manipulate such views to monitor any equipment desired. The technology to prepare and navigate such views is well known and used in video games and in providing so called “virtual tours” as well as 3-D modeling software.

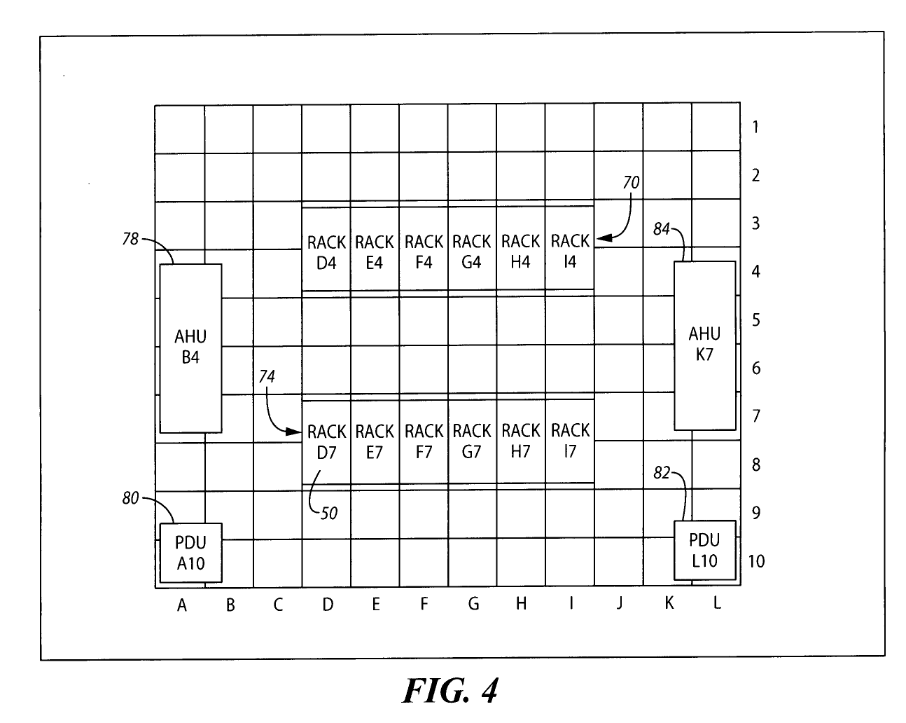

One exemplary embodiment of such views is depicted in FIG. 4 in a two dimensional overhead view of a data center is depicted (note that a three dimensional view could also be generated. In this example, as described above, two parallel multiple rack server arrangements 70 and 74 are provided in the middle of the room with additional equipment 78, 80, 82 and 84 arranged along the walls. Rack 50 as shown in FIG. 2 is shown at the end (room coordinates D7) of row 74. This view might provide a general overview of the room with the display showing a color-coded indicating the highest temperature in any piece of equipment in a particular rack. If a problem area is identified, for example in rack D7, the view of FIG. 2 or other more detailed view can be displayed to localize the problem area even further. This can be accomplished by clicking or double clicking a pointing device (e.g., a mouse or trackball device) on the box representing the problem item.

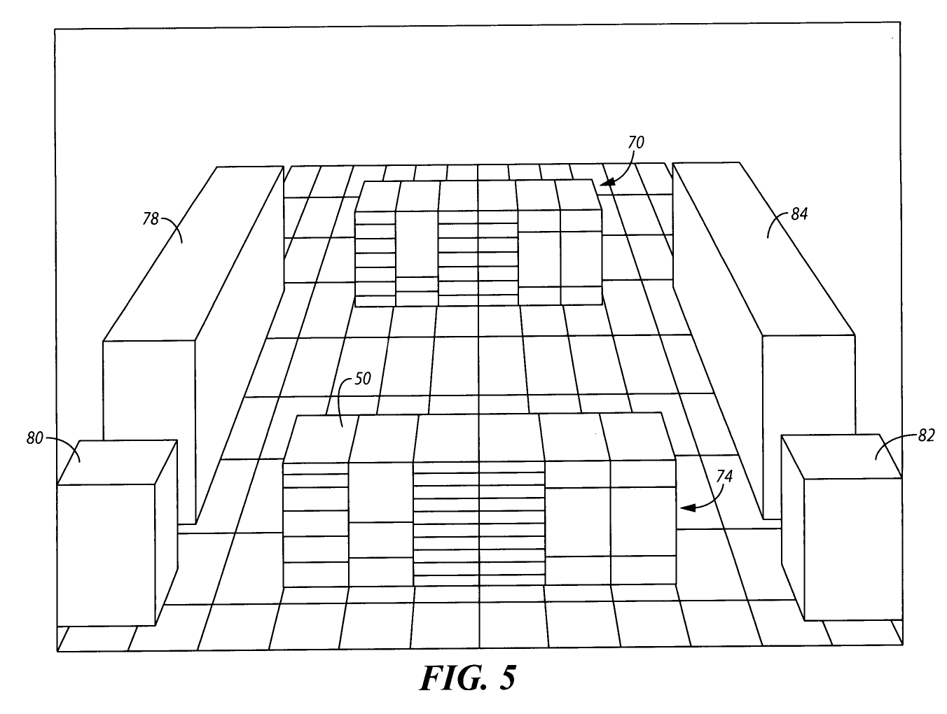

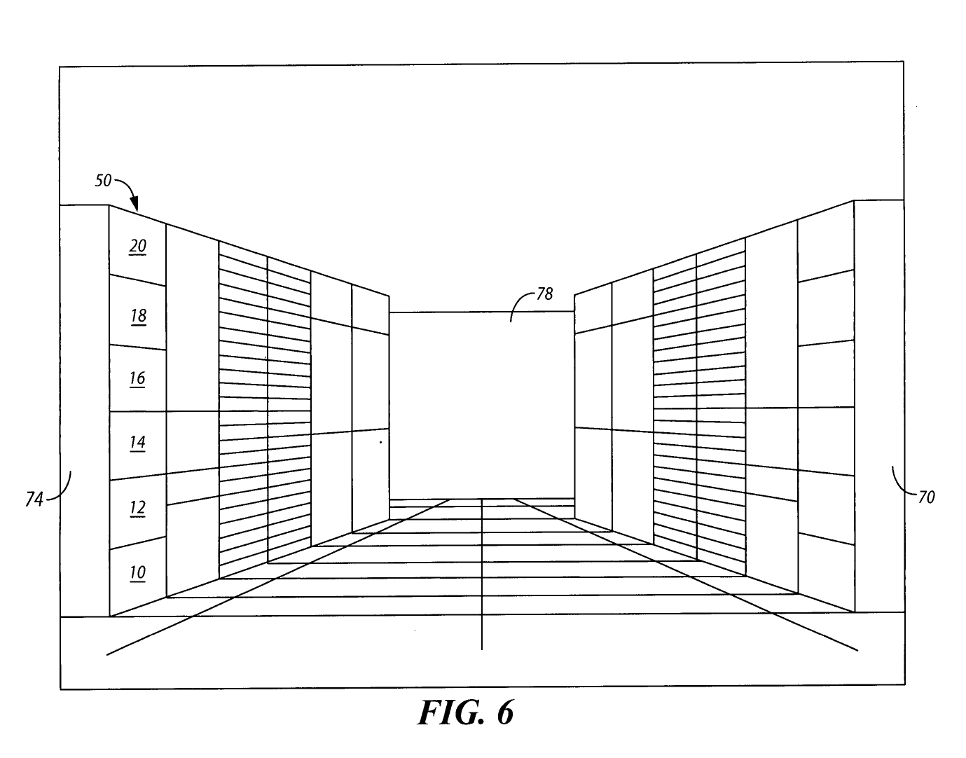

In addition, if the operator wishes to see another view of the room, he can pan around the room using any known panning mechanism for computer images. FIG. 5 depicts a three-dimensional upper side view of the room. Various three-dimensional images with tilt, pan, rotate, move and zoom allow significantly more data to be examined from different viewpoints to quickly spot areas of concern. FIG. 6 depicts a view looking down the row between racks 70 and 74 permitting the operator to view not only rack 50 in isolation, but together with all equipment in rows 70 and 74. Other views can also be constructed in a manner consistent with certain embodiments.

Thus, a process of monitoring a predetermined parameter in each of a plurality of electrical devices located in a locality, consistent with certain embodiments, involves generating a user navigable graphical display of graphical representations of the devices as positioned in the locality; and coloring each of the graphical representations of the devices with a predetermined color corresponding to a currently measured value of the predetermined parameter for the corresponding device. When parameters are updated, the process receives an updated measured value of the predetermined parameter and re-generates the user navigable graphical display of graphical representations of the devices as positioned in the locality including re-coloring each of the graphical representations of the devices with a predetermined color corresponding to the updated measured value of the predetermined parameter for the corresponding device.

When a navigation input is received from a user interface that indicates a change in view has been selected by an operator, the graphic display can be re-displayed to change to the view selected by the operator. The view selected by the operator can be, for example, a panned view, a rotated view, a tilted view, a moved view or a zoomed view of the graphic representation. The graphic representation can be either two-dimensional or three-dimensional.

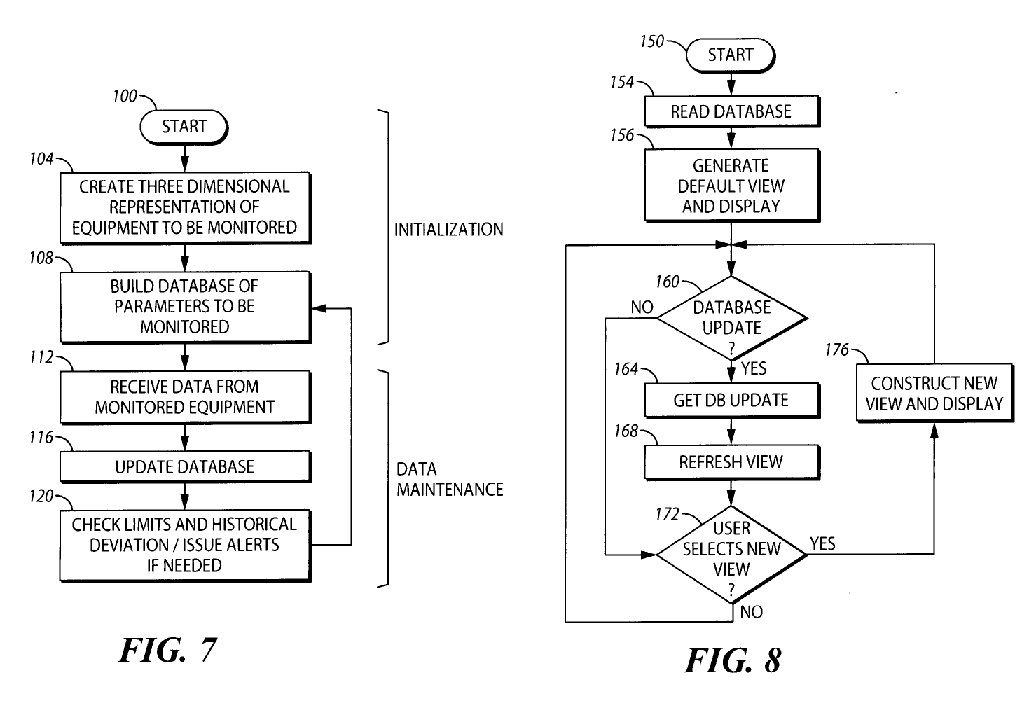

A process overview for depicting a collection of equipment graphically and displaying the operational parameters in color-coded form is depicted in FIG. 7. The process starts at 100 and at 104 a graphical representation (preferably a three-dimensional representation) is created that depicts the physical arrangement of all equipment to be monitored. A database of parameters to be monitored is then created at 108. The database configuration will depend upon the number and nature of parameters that are to be monitored. The database incorporates a table that defines colors for a particular range of the parameters to be monitored (e.g., temperature, power, current, etc.) or equipment status. If the main parameter to be measured is temperature, a table such as the following can be constructed as a part of the database in which monitored equipment that reports temperatures is color coded in the third through seventh rows, and equipment that has an identifier but is not present or is presenting an error condition is color coded using the first two rows.

| Status | Max temperature | Min temperature | Color |
|---|---|---|---|
| Not Present | | | White |
| Error | | | Gray |
| Monitored | 40° C. | | Blue |
| Monitored | 60° C. | 41° C. | Green |
| Monitored | 80° C. | 61° C. | Yellow |
| Monitored | 100° C. | 81° C. | Orange |
| Monitored | | 101° C. | Red |

Another table can be constructed that relates equipment identifiers to graphical elements in the graphical representation of the equipment and to data read for the equipment. Such information may appear similar to the following table:

| Equipment | Graphic | Temp | Current | Voltage | | |
|---|---|---|---|---|---|---|
| ID | element | (° C.) | (Amps) | (Volts) | Monitored | Functional |
| . | . | . | . | . | . | . |
| . | . | . | . | . | . | . |
| . | . | . | . | . | . | . |
| D7-1 | 43 | 22 | 5.5 | 117 | Yes | Yes |
| D7-2 | 44 | 104 | 14 | 113 | Yes | Yes |
| D7-3 | 45 | 34 | 5.5 | 117 | Yes | Yes |
| D7-4 | 46 | 84 | 11.9 | 117 | Yes | Yes |
| D7-5 | 47 | 68 | 10.1 | 117 | Yes | Yes |
| . | . | . | . | . | . | . |
| . | . | . | . | . | . | . |
| . | . | . | . | . | . | . |

The information for this table relates the equipment identifier to the graphic elements used to construct the various views. This database table can also store the various operational parameters (e.g., temperature, current, voltage, etc.) being monitored. In this case, the temperature is color coded according to the prior table. The “monitored” column indicates that the equipment is being monitored and should not appear as a white unmonitored box in the graphic depiction. The “functional” column indicates that the computer 32 is receiving regular updates (e.g., as a result of polls or other established communication protocol) from the device's monitoring circuitry. Failure to receive a regular update will result in this parameter changing to “no” and the equipment being depicted as gray (in this example). The gray depiction indicates that service of the monitoring circuit or equipment being monitored may be needed since an error condition is present.

Once the database and image are created, the initialization stage of the software setup is complete. The data are then received from the monitored equipment (e.g., via network 24, direct connection or any other suitable communication protocol) at 112. The database is then periodically updated by readings from the sensors residing within or otherwise associated with the equipment being monitored at 116. This data can then be checked against user defined limits and/or historical data at 120 before returning to 112 for another iteration of data collection. At 120 the data are checked and compared to static limits and historical values. Alarms, warnings or errors can be issued to the user if the data exceeds previously established thresholds or historical levels. Notification of the user of such deviations can take place using any of a number of mechanisms. This is the data maintenance phase and this phase may be in continual operation such that data are received and the database may be constantly or periodically updated. Thus, FIG. 7 describes a computer program operation that carries out an iterative data collection process. This program retrieves the data, updates the data, and monitors the data in order to be able to issue alarms, warnings and errors.

The monitoring software, in certain embodiments, may operate in accordance with the flow chart of FIG. 8 starting at 150. This process describes the program used by a technician to monitor and visually display the data collected in the process of FIG. 7. At 154 the database is read and a default view mapping the equipment is generated and displayed at 156. This default view retrieves a graphical representation created at 104 and maps this data from the database with the color-coding associated with the measured parameter to provide a color-coded display. As the database is updated at 160, the updates are retrieved at 164 and the view is refreshed with new color-coding or text data at 168 and control passes to 172. If no database update has been made, control may pass directly from 160 to 172. If the user selects a new view (e.g., a zoom, tilt, rotation, move or pan), the new view is constructed 176 from the graphical representation with the data from the database used to provide color and text data where possible and control returns to 160 to await the next database update. If no new view is selected, control returns to 160 to await the next database update.

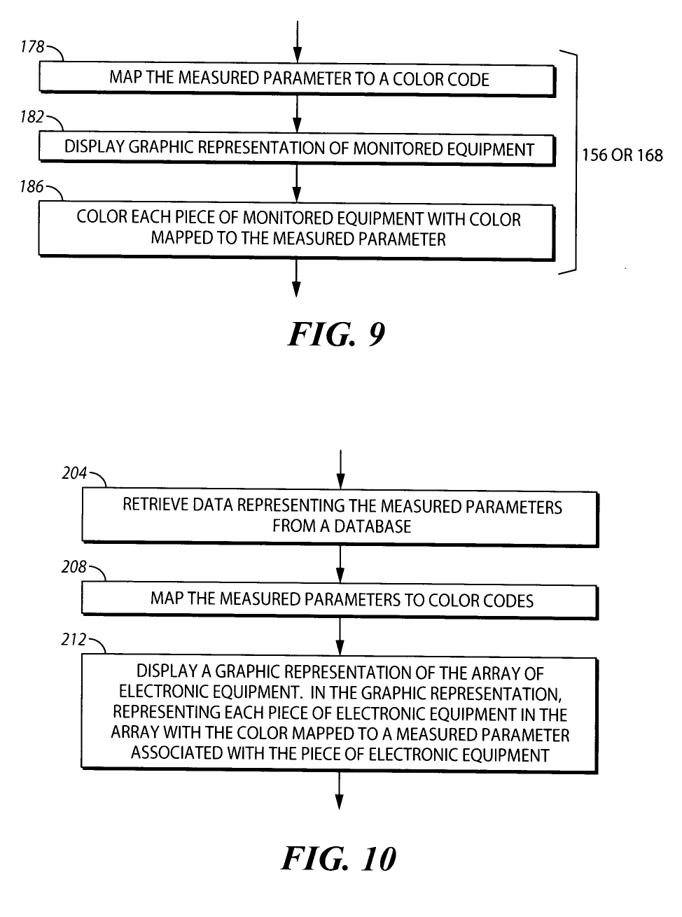

With reference to FIG. 9, the operations carried out in blocks 156 and 168 of FIG. 8 are depicted in greater detail. At 178, the measured parameter (e.g., temperature or power) is mapped to a color code using the table in the database described above. This is carried out for each piece of equipment in the display. At 182, a graphic representation of the array of monitored electronic equipment as created in 104 for the particular view selected by the user, is created. At 186, each piece of electronic equipment in the array of equipment displayed is colored with the color mapped to the measured parameter.

The temperatures and/or other parameters are read from the servers or other equipment, e.g., at set intervals, and entered into the database. Alarms may be programmed for specific equipment or general trends. The display preferably updates at the same interval as the data collection. The interval may be user definable or preset. The user may also specify the equipment to be monitored. By maintaining historical data from the database, the historical data can be evaluated to determine trends in order to better understand the meaning of the various parameters and compare them to current readings. This provides the ability for a monitor system to provide an alarm on that data or to display. The data can also be displayed as a difference chart, as well. Other variations will also occur to those skilled in the art in view of the present teachings.

In one exemplary embodiment as depicted in FIG. 10, a method of monitoring measured parameters associated with each piece of equipment in an array of electronic equipment, is provided. The method involves retrieving data representing the measured parameters from a database at 204, mapping the measured parameters to color codes at 208, and displaying a graphic representation of the array of electronic equipment at 212. In the graphic representation, each piece of electronic equipment in the array is represented with the color mapped to a measured parameter associated with the piece of electronic equipment.

In another embodiment, a computer readable storage medium may be used to store instructions that, when executed on a programmed processor, carry out a method of monitoring measured parameters associated with each piece of equipment in an array of electronic equipment, wherein the instructions provide for retrieving data representing the measured parameters from a database; mapping the measured parameters to color codes; displaying a graphic representation of the array of electronic equipment; and in the graphic representation, representing each piece of electronic equipment in the array with the color mapped to a measured parameter associated with the piece of electronic equipment.

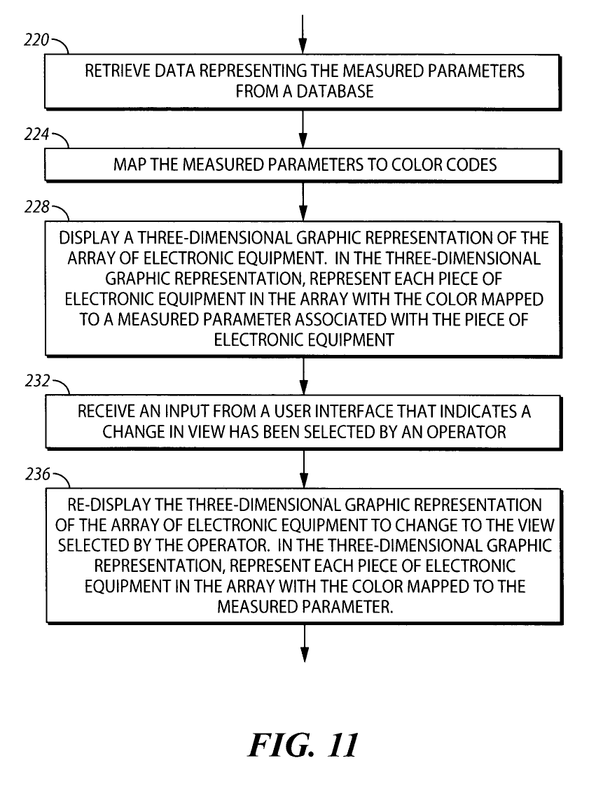

FIG. 11 depicts an exemplary method of displaying measured parameters associated with each piece of equipment in an array of electronic equipment, which involves retrieving data representing the measured parameters from a database at 220; mapping the measured parameters to color codes at 224; displaying a three-dimensional graphic representation of the array of electronic equipment at 228; in the three-dimensional graphic representation, representing each piece of electronic equipment in the array with the color mapped to a measured parameter associated with the piece of electronic equipment; receiving an input from a user interface that indicates a change in view has been selected by an operator at 232; re-displaying the three-dimensional graphic representation of the array of electronic equipment to change to the view selected by the operator at 236; and in the three-dimensional graphic representation, representing each piece of electronic equipment in the array with the color mapped to the measured parameter.

In another embodiment, a computer readable storage medium can store instructions that, when executed on a programmed processor, carry out a method of displaying measured parameters associated with each piece of equipment in an array of electronic equipment, wherein the instructions provide for retrieving data representing the measured parameters from a database; mapping the measured parameters to color codes; displaying a three-dimensional graphic representation of the array of electronic equipment; in the three-dimensional graphic representation, representing each piece of electronic equipment in the array with the color mapped to a measured parameter associated with the piece of electronic equipment; receiving an input from a user interface that indicates a change in view has been selected by an operator; re-displaying the three-dimensional graphic representation of the array of electronic equipment to change to the view selected by the operator; and in the three-dimensional graphic representation, representing each piece of electronic equipment in the array with the color mapped to the measured parameter.

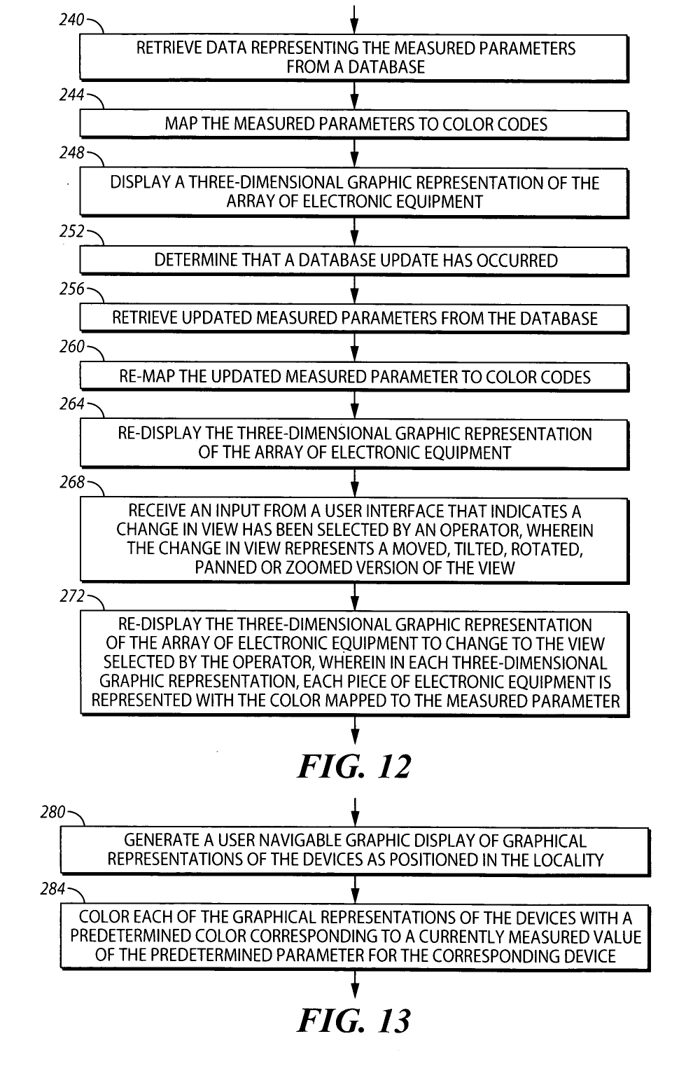

FIG. 12 depicts an exemplary method of displaying measured parameters associated with each piece of equipment in an array of electronic equipment, which involves retrieving data representing the measured parameters from a database at 240; mapping the measured parameters to color codes at 244; displaying a three-dimensional graphic representation of the array of electronic equipment at 248; determining that a database update has occurred at 252; retrieving updated measured parameters from the database at 256; re-mapping the updated measured parameter to color codes at 260; re-displaying the three-dimensional graphic representation of the array of electronic equipment at 264; receiving an input from a user interface that indicates a change in view has been selected by an operator at 268, wherein the change in view represents a moved, tilted, rotated, panned or zoomed version of the view; re-displaying the three-dimensional graphic representation of the array of electronic equipment to change to the view selected by the operator 272; and wherein in each three-dimensional graphic representation, each piece of electronic equipment is represented with the color mapped to the measured parameter.

In certain embodiments, a computer readable storage medium can store instructions that, when executed on a programmed processor, implement a method of displaying measured parameters associated with each piece of equipment in an array of electronic equipment, the instructions can carry out the method by retrieving data representing the measured parameters from a database; mapping the measured parameters to color codes; rendering a graphic representation of the array of electronic equipment for display on a display; and in the graphic representation, representing each piece of electronic equipment in the array with the color mapped to a measured parameter associated with the piece of electronic equipment.

In certain other embodiments, a system that displays measured parameters associated with a plurality of pieces of equipment in an array of electronic equipment has a communication circuit for receiving data representing the measured parameters from the plurality of pieces of equipment. A computer can be programmed to carry out the functions of receive the data and store the data in a database that relates the measured parameters to the plurality of pieces of equipment; mapping the measured parameters to color codes; rendering a graphic representation of the array of electronic equipment; and wherein, in the graphic representation, each piece of electronic equipment in the array is represented with the color mapped to a measured parameter associated with the piece of electronic equipment.

In other embodiments, an apparatus for monitoring measured parameters associated with each piece of equipment in an array of electronic equipment, has circuitry which retrieves data representing the measured parameters from a database. Further circuitry maps the measured parameters to color codes; and other circuitry presents a graphic representation of the array of electronic equipment to a display, wherein in the graphic representation, each piece of electronic equipment in the array is represented with the color mapped to a measured parameter associated with the piece of electronic equipment.

In another exemplary embodiment depicted in FIG. 13, a method of monitoring a predetermined parameter in each of a plurality of electrical devices located in a locality, involves generating a user navigable graphical display of graphical representations of the devices as positioned in the locality at 280; and coloring each of the graphical representations of the devices with a predetermined color corresponding to a currently measured value of the predetermined parameter for the corresponding device at 284.

Certain exemplary embodiments may be based upon use of a programmed processor such as computer 32 operating in conjunction with the monitoring devices described above. Other embodiments may use, for example, hardware component equivalents such as special purpose hardware and/or dedicated processors which should become evident to one of ordinary skill in the art upon consideration of the present disclosure. Similarly, general purpose computers, microprocessor based computers, micro-controllers, optical computers, analog computers, dedicated processors and/or dedicated hard wired logic may be used in certain embodiments.

Those skilled in the art will appreciate, after consideration of this disclosure, that the program steps and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory, core memory and/or other equivalent storage technologies may be employed in various alternative embodiments.

Certain embodiments may be implemented using a programmed processor executing programming instructions that are broadly described above and that can be stored on any suitable electronic storage medium or transmitted over any suitable electronic communication medium. However, those skilled in the art will appreciate, upon considering the present disclosure, that the processes described above can be implemented in any number of variations and in many suitable programming languages without departing from certain embodiments. For example, the order of certain operations carried out can often be varied, additional operations can be added or operations can be deleted without departing from certain embodiments. Error trapping can be added and/or enhanced and variations can be made in user interface and information presentation without departing from certain embodiments.

While certain embodiments have been described herein, many alternatives, modifications, permutations and variations that are consistent with other embodiments will become apparent to those of ordinary skill in the art in light of the foregoing description.

1. A method of monitoring measured parameters associated with each piece of equipment in an array of electronic equipment, comprising:
retrieving data representing the measured parameters from a database;
mapping the measured parameters to color codes;
displaying a graphic representation of the array of electronic equipment; and
in the graphic representation, representing each piece of electronic equipment in the array with the color mapped to a measured parameter associated with the piece of electronic equipment.

2. The method according to claim 1, further comprising:
determining that a database update has occurred;
retrieving updated measured parameters from the database;
mapping the updated measured parameter to color codes;
re-displaying the graphic representation of the array of electronic equipment; and
in the graphic representation, representing each piece of electronic equipment in the array with the color mapped to the updated measured parameter.

3. The method according to claim 1, further comprising:
receiving an input from a user interface that indicates a change in view has been selected by an operator;
re-displaying the graphic representation of the array of electronic equipment to change to the view selected by the operator; and
in the graphic representation, representing each piece of electronic equipment in the array with the color mapped to the measured parameter.

4. The method according to claim 3, wherein the view selected by the operator comprises one of a panned view, a rotated view, a tilted view, a moved view and a zoomed view of the graphic representation.

5. The method according to claim 3, wherein the graphic representation comprises a three-dimensional graphic representation, and wherein the view selected by the operator comprises one of a panned view, a rotated view, a tilted view, a moved view and a zoomed view of the graphic representation.

6. The method according to claim 1, wherein the graphic representation comprises a three-dimensional graphic representation.

7. The method according to claim 1, wherein the graphic representation comprises a two-dimensional graphic representation.

8. The method according to claim 1, wherein the measured parameter comprises one of temperature, power, current and voltage.

9. The method according to claim 1, carried out in a programmed processor.

10. A computer readable storage medium storing instructions that, when executed on a programmed processor, carry out a method of monitoring measured parameters associated with each piece of equipment in an array of electronic equipment, comprising:
retrieving data representing the measured parameters from a database;
mapping the measured parameters to color codes;
displaying a graphic representation of the array of electronic equipment; and
in the graphic representation, representing each piece of electronic equipment in the array with the color mapped to a measured parameter associated with the piece of electronic equipment.

11. A method of displaying measured parameters associated with each piece of equipment in an array of electronic equipment, comprising:
retrieving data representing the measured parameters from a database;
mapping the measured parameters to color codes;
displaying a three-dimensional graphic representation of the array of electronic equipment;
in the three-dimensional graphic representation, representing each piece of electronic equipment in the array with the color mapped to a measured parameter associated with the piece of electronic equipment;
receiving an input from a user interface that indicates a change in view has been selected by an operator;
re-displaying the three-dimensional graphic representation of the array of electronic equipment to change to the view selected by the operator; and
in the three-dimensional graphic representation, representing each piece of electronic equipment in the array with the color mapped to the measured parameter.

12. The method according to claim 11, further comprising:
determining that a database update has occurred;
retrieving updated measured parameters from the database;
mapping the updated measured parameter to color codes;
re-displaying the three-dimensional graphic representation of the array of electronic equipment; and
in the three-dimensional graphic representation, representing each piece of electronic equipment in the array with the color mapped to the updated measured parameter.

13. The method according to claim 11, wherein the view selected by the operator comprises one of a panned view, a rotated view, a tilted view, a moved view and a zoomed view of the three-dimensional graphic representation.

14. The method according to claim 11, wherein the measured parameter comprises one of temperature, power, current and voltage.

15. The method according to claim 11, further comprising receiving updated parameters from the electronic equipment and storing the updated parameters in the database.

16. The method according to claim 11, carried out in a programmed processor.

17. A computer readable storage medium storing instructions that, when executed on a programmed processor, carry out a method of displaying measured parameters associated with each piece of equipment in an array of electronic equipment, comprising:
retrieving data representing the measured parameters from a database;
mapping the measured parameters to color codes;
displaying a three-dimensional graphic representation of the array of electronic equipment;
in the three-dimensional graphic representation, representing each piece of electronic equipment in the array with the color mapped to a measured parameter associated with the piece of electronic equipment;
receiving an input from a user interface that indicates a change in view has been selected by an operator;
re-displaying the three-dimensional graphic representation of the array of electronic equipment to change to the view selected by the operator; and
in the three-dimensional graphic representation, representing each piece of electronic equipment in the array with the color mapped to the measured parameter.

18. A method of displaying measured parameters associated with each piece of equipment in an array of electronic equipment, comprising:
retrieving data representing the measured parameters from a database;
mapping the measured parameters to color codes;
displaying a three-dimensional graphic representation of the array of electronic equipment;
determining that a database update has occurred;
retrieving updated measured parameters from the database;
re-mapping the updated measured parameter to color codes;
re-displaying the three-dimensional graphic representation of the array of electronic equipment;
receiving an input from a user interface that indicates a change in view has been selected by an operator, wherein the change in view represents a moved, tilted, rotated, panned or zoomed version of the view;
re-displaying the three-dimensional graphic representation of the array of electronic equipment to change to the view selected by the operator; and
wherein in each three-dimensional graphic representation, each piece of electronic equipment is represented with the color mapped to the measured parameter.

19. The method according to claim 18, wherein the measured parameter comprises one of temperature, power, current and voltage.

20. A computer readable storage medium storing instructions that, when executed on a programmed processor, implement a method of displaying measured parameters associated with each piece of equipment in an array of electronic equipment, the instructions carrying out the method by:
retrieving data representing the measured parameters from a database;
mapping the measured parameters to color codes;
rendering a graphic representation of the array of electronic equipment for display on a display; and
in the graphic representation, representing each piece of electronic equipment in the array with the color mapped to a measured parameter associated with the piece of electronic equipment.

21. The storage medium according to claim 20, the instructions further carry out the method by:
determining that a database update has occurred;
retrieving updated measured parameters from the database;
mapping the updated measured parameter to color codes;
re-displaying the graphic representation of the array of electronic equipment; and
in the graphic representation, representing each piece of electronic equipment in the array with the color mapped to the updated measured parameter.

22. The storage medium according to claim 20, the instructions further carry out the method by:
receiving an input from a user interface that indicates a change in view has been selected by an operator;
re-displaying the graphic representation of the array of electronic equipment to change to the view selected by the operator; and
in the graphic representation, representing each piece of electronic equipment in the array with the color mapped to the measured parameter.

23. The storage medium according to claim 22 wherein the view selected by the operator comprises one of a panned view, a rotated view, a tilted view, a moved view and a zoomed view of the graphic representation.

24. The storage medium according to claim 20, wherein the graphic representation comprises a three-dimensional graphic representation, and wherein the view selected by the operator comprises one of a panned view, a rotated view, a tilted view, a moved view and a zoomed view of the graphic representation.

25. The storage medium according to claim 20, wherein the graphic representation comprises a three-dimensional graphic representation.

26. The storage medium according to claim 20, the instructions further carry out the method by receiving updated parameters from the electronic equipment and storing the updated parameters in the database.

27. A system that displays measured parameters associated with a plurality of pieces of equipment in an array of electronic equipment, comprising:
a communication circuit that receives data representing the measured parameters from the plurality of pieces of equipment;
a computer programmed to carry out the functions of:
receiving the data and store the data in a database that relates the measured parameters to the plurality of pieces of equipment;
mapping the measured parameters to color codes;
rendering a graphic representation of the array of electronic equipment; and
wherein, in the graphic representation, each piece of electronic equipment in the array is represented with the color mapped to a measured parameter associated with the piece of electronic equipment.

28. The system according to claim 27, further comprising:
wherein the communication circuit comprises updates the database with new data on a periodic basis;
and wherein the computer program further carries out the functions of:
retrieving updated measured parameters from the database;
mapping the updated measured parameter to color codes;
creating a new rendering of the graphic representation of the array of electronic equipment; and
wherein, in the graphic representation, each piece of electronic equipment in the array is represented with the color mapped to the updated measured parameter.

29. The system according to claim 27, further comprising:
a user interface that receives input that indicates a change in view has been selected by an operator;
and wherein the computer program includes graphics rendering code that renders a new graphic representation of the array of electronic equipment to change to the view selected by the operator; and
wherein in the graphic representation, each piece of electronic equipment in the array is represented with the color mapped to the measured parameter.

30. The system according to claim 29, wherein the view selected by the operator comprises one of a panned view and a zoomed view of the graphic representation.

31. The system according to claim 29, wherein the graphic representation comprises a three-dimensional graphic representation, and wherein the view selected by the operator comprises one of a panned view and a zoomed view of the graphic representation.

32. The system according to claim 27, wherein the graphic representation comprises a three-dimensional graphic representation.

33. The system according to claim 27, wherein the graphic representation comprises a two-dimensional graphic representation.

34. The system according to claim 27, wherein the measured parameter comprises one of temperature, power, current and voltage.

35. An apparatus for monitoring measured parameters associated with each piece of equipment in an array of electronic equipment, comprising:
means for retrieving data representing the measured parameters from a database;
means for mapping the measured parameters to color codes; and
means for presenting a graphic representation of the array of electronic equipment to a display, wherein in the graphic representation, each piece of electronic equipment in the array is represented with the color mapped to a measured parameter associated with the piece of electronic equipment.

36. The apparatus according to claim 35, further comprising:
means for determining that a database update has occurred,
wherein, the means for retrieving retrieves updated measured parameters from the database;
wherein the means for mapping re-maps the updated measured parameter to color codes; and
wherein the means for presenting presents updates the information presented to the display; and
wherein, in the graphic representation, each piece of electronic equipment in the array is represented by the color re-mapped to the updated measured parameter.

37. The apparatus according to claim 35, further comprising:
means for receiving an input from a user interface that indicates a change in view has been selected by an operator, wherein the means for presenting represents a graphic representation of the array of electronic equipment to change to the view selected by the operator, wherein, in the graphic representation, each piece of electronic equipment in the array is represented by the color mapped to the measured parameter.

38. A method of monitoring a predetermined parameter in each of a plurality of electrical devices located in a locality, comprising:
generating a user navigable graphical display of graphical representations of the devices as positioned in the locality; and
coloring each of the graphical representations of the devices with a predetermined color corresponding to a currently measured value of the predetermined parameter for the corresponding device.

39. The method according to claim 38, further comprising:
receiving an updated measured value of the predetermined parameter;
re-generating the user navigable graphical display of graphical representations of the devices as positioned in the locality; and
re-coloring each of the graphical representations of the devices with a predetermined color corresponding to the updated measured value of the predetermined parameter for the corresponding device.

40. The method according to claim 39, further comprising:
receiving a navigation input from a user interface that indicates a change in view has been selected by an operator;
re-generating the graphic display to change to the view selected by the operator.

41. The method according to claim 40, wherein the view selected by the operator comprises one of a panned view, a rotated view, a tilted view, a moved view and a zoomed view of the graphic representation.

42. The method according to claim 40, wherein the graphic representation comprises a three-dimensional graphic representation, and wherein the view selected by the operator comprises one of a panned view, a rotated view, a tilted view, a moved view and a zoomed view of the graphic representation.

43. The method according to claim 38, wherein the graphic representation comprises a three-dimensional graphic representation.

44. The method according to claim 38, wherein the graphic representation comprises a two-dimensional graphic representation.

45. The method according to claim 38, wherein the measured parameter comprises one of temperature, power, current and voltage.
